(19) United States
(12) Patent Application Publication
(10) Pub. No.: US 2020/0209463 A1
(43) Pub. Date: Jul. 2, 2020

(54) LIGHT GUIDE PLATE AND DISPLAY DEVICE INCLUDING THE SAME

(71) Applicant: SUMSUNG DISPLAY CO., LTD., YONGIN-SI (KR)

(72) Inventors: YU BIN KIM, SUWON-SI (KR); JEONG MIN SEO, YONGIN-SI (KR); JIN HYUK PARK, HWASEONG-SI (KR); WON CHUL LEE, SEOUL (KR)

(21) Appl. No.: 16/550,858

(22) Filed: Aug. 26, 2019

(30) Foreign Application Priority Data
Jan. 2, 2019 (KR) 10-2019-0000302
May 10, 2019 (KR) 10-2019-0055129

(51) Int. Cl. F21V 8/00; G02F 1/13357; G02F 1/1677

(52) U.S. Cl. CPC G02B 6/0058; G02B 6/0088; G02B 6/0043; G02F 2001/133614; G02B 6/0091; G02F 1/1677; G02F 1/1336

(57) ABSTRACT

Provided are a light guide plate and a display device. The light guide plate includes a supporting part that includes a first surface, a second surface opposite to the first surface, and side surfaces that connect the first and second surfaces. The first surface includes a first curved area that has a first curvature radius, and a center of the first curvature radius is located above the first surface.

### CROSS REFERENCE TO RELATED APPLICATIONS

This application claims priority under 35 U.S.C. § 119 from, and the benefit of, Korean Patent Application No. 10-2019-0000302, filed on Jan. 2, 2019 and Korean Patent Application No. 10-2019-0055129, filed on May 10, 2019 in the Korean Intellectual. Property Office, the contents of which are herein incorporated by reference in their entirety.

### BACKGROUND

### 1. Technical Field

Embodiments of the present disclosure are directed to a light guide plate and a display device including the same.

### 2. Discussion of the Related Art

A liquid crystal display (LCD) device receives light from a backlight assembly and displays an image. The backlight assembly includes a light source module and a light guide plate. The light guide plate receives light from the light source module and guides the light toward the display panel. Light provided by the light source module is typically white light, and colors can be realized by filtering the white light through color filters.

Recently, research has been conducted on the use of a wavelength conversion film to improve the display quality, such as color reproducibility, of an LCD device. Typically, a blue light source module is used, and the wavelength conversion film is placed above a light guide plate to convert blue light into white light. The wavelength conversion film includes wavelength conversion particles. However, the wavelength conversion particles are susceptible to moisture, and thus barrier films are used to protect the wavelength conversion particles. However, the barrier films are generally expensive and increase the thickness of the entire light guide plate. Also, a complicated assembly process is used to deposit the wavelength conversion film on the light guide plate.

In addition, curved display devices have become increasingly commercialized. For example, a curved display device can be firmed on a plastic substrate that can be bent. A curved display device can realize various design features and has improved portability, improved durability, and an improved sense of immersion.

### SUMMARY

Embodiments of the present disclosure can provide a curved light guide plate with a reduced risk of cracking and a display device including the same.

However, embodiments of the present disclosure are not restricted to those set forth herein. The above and other embodiments of the present disclosure will become more apparent to one of ordinary skill in the art to which the present disclosure pertains by referencing the detailed description of the present disclosure given below.

According to an embodiment of the present disclosure, a light guide plate comprises a supporting part that includes a first surface, a second surface opposite to the first surface, and side surfaces that connect the first and second surfaces. The first surface includes a first curved area that has a first curvature radius, and a center of the first curvature radius is located above the first surface.

The supporting part may include an inorganic material.

The second surface of the supporting part may be flat.

A thickness of the supporting part, which is a distance between the first and second surfaces, may vary from one part to another part of the supporting part. The supporting part may have a maximum thickness in areas near the side surfaces of the supporting part and may have a minimum thickness at a center of the supporting part, and the minimum thickness of the supporting part is 0.4 to 0.6 times the maximum thickness of the supporting part.

The light guide plate may further comprise a first relieving part disposed directly on the first curved area of the supporting part. A maximum thickness of the first relieving part is less than the maximum thickness of the supporting part, and the first relieving part may include an organic material.

The first relieving part may include a third surface in contact with the first surface of the supporting part, and a fourth surface opposite to the third surface. The fourth surface of the first relieving part may be parallel to the second surface of the supporting part.

The first relieving part may further include a plurality of scattering patterns formed on the fourth surface.

A difference in refractive index between the supporting part and the first relieving part may be 5% or less.

The first relieving part may have a refractive index of 1.4 to 1.6.

The second surface of the supporting part may include a second curved area that has a second curvature radius. A center of the second curvature radius may be located above the second surface.

The light guide plate may further comprise a second relieving part disposed directly on the second curved area of the supporting part. The second relieving part may include an organic material.

According to another embodiment of the present disclosure, a display device comprises a light guide plate, a wavelength conversion layer disposed on the light guide plate, a display panel disposed on the wavelength conversion layer, and a light source module disposed adjacent to one side surface of the light guide plate. The light guide plate includes a supporting part that includes a first surface, a second surface opposite to the first surface, and side surfaces that connect the first and second surfaces, and a relieving part that includes a third surface in contact with the second surface of the supporting part and a fourth surface opposite to the third surface. The first surface of the supporting part includes a first curved area that has a first curvature radius. The second surface of the supporting part includes a second curved area that has a second curvature radius. The first and second curvature radii satisfy one of the following conditions (a) and (b): (a) the second curvature radius is greater than the first curvature radius; and (b) a center of the first curvature radius is located above the first surface, and a center of the second curvature radius is located above the second surface.

The supporting part may include an inorganic material. The relieving part may include an organic material. The wavelength conversion layer may include quantum dots.

The first curvature radius may be 1500 mm to 1800 mm.

The fourth surface may include a third curved area having a third curvature radius. The third curvature radius may be greater than the first curvature radius.

The first and third curved areas may be parallel to each other.

The first surface of the supporting part may further include flat areas disposed on both sides of the first curved area.

The relieving part may overlap the first curved area of the supporting part.

According to another embodiment of the present disclosure, a light guide plate comprises a supporting part that includes a first surface and a second surface opposite to the first surface, wherein the first surface includes a first curved area that has a first curvature radius; and a relieving part disposed directly on the first curved area of the supporting part. A difference in refractive index between the supporting part and the relieving part is 5% or less.

The supporting part may further comprise side surfaces that connect the first and second surfaces. A thickness of the supporting part, which is a distance between the first and second surfaces, may vary from one part to another part of the supporting part. The supporting part may have a maximum thickness in areas near the side surfaces of the supporting part and has a minimum thickness at a center of the supporting part. A maximum thickness of the relieving part may be less than the maximum thickness of the supporting part.

According to the aforementioned and other embodiments of the present disclosure, a light guide plate can be bent without cracking and to have a large curvature.

Other features and embodiments may be apparent from the following detailed description, the drawings, and the claims.

### BRIEF DESCRIPTION OF THE DRAWINGS

FIG. 1 is a perspective view of a display device according to an embodiment of the present disclosure.

FIG. 2 is a cross-sectional view taken along line I-I′ of FIG. 1.

FIG. 3 is a perspective view of a supporting part of a light guide plate that has not yet been subjected to a curving step.

FIG. 4 is a cross-sectional view taken along line II-II′ of FIG. 3.

FIG. 5 is a cross-sectional view of a supporting part of a light guide plate that has already been subjected to a curving step.

FIG. 6 is a cross-sectional view that illustrates a case where a first relieving part is coupled to a light guide plate of FIG. 4.

FIG. 7 is a cross-sectional view that illustrates a case where a first relieving part is coupled to a light guide plate of FIG. 5.

FIGS. 8 through 10 are cross-sectional views of light guide plates according to other embodiments of the present disclosure, which have already been subjected to a curving step.

FIGS. 11 and 12 are cross-sectional views of a light guide plate according to an embodiment of the present disclosure.

FIG. 13 is a cross-sectional view of a light guide plate according to an embodiment of the present disclosure, which has not yet been subjected to a curving step.

FIG. 14 is a cross-sectional view of a light guide plate obtained by subjecting a light guide plate of FIG. 13 to a curving step.

FIG. 15 is a perspective view of a light guide plate according to an embodiment of the present disclosure, which has already been subjected to a curving step.

FIG. 16 is a cross-sectional view taken along line III-III′ of FIG. 15.

FIG. 17 is a perspective view of a light guide plate according to an embodiment of the present disclosure, which has already been subjected to a curving step.

FIG. 18 is a cross-sectional view taken along line IV-IV′ of FIG. 17.

### DETAILED DESCRIPTION

Features of embodiments of the disclosure and methods for achieving the features will be apparent by referring to exemplary embodiments to be described in detail with reference to the accompanying drawings. However, embodiments of the disclosure are not limited to exemplary embodiments disclosed hereinafter, but can be implemented in diverse forms.

Where an element is described as being related to another element such as being “on” another element or “located on” a different layer or a layer, includes both a case where an element is located directly on another element or a layer and a case where an element is located on another element via another layer or still another element. In the disclosure, the same drawing reference numerals may be used for the same elements across various figures.

Display devices according to various embodiments of the present disclosure can display still or moving images or stereoscopic images and can be used not only in mobile electronic devices such as mobile communication terminals, smartphones, tablets, smartwatches, and navigation devices, but also in various other products such as televisions, laptop computers, monitors, billboards, and Internet-of-Things (IoT) products.

Embodiments of the present disclosure will hereinafter be described with reference to the accompanying drawings. In the drawings, like reference numerals may indicate like elements.

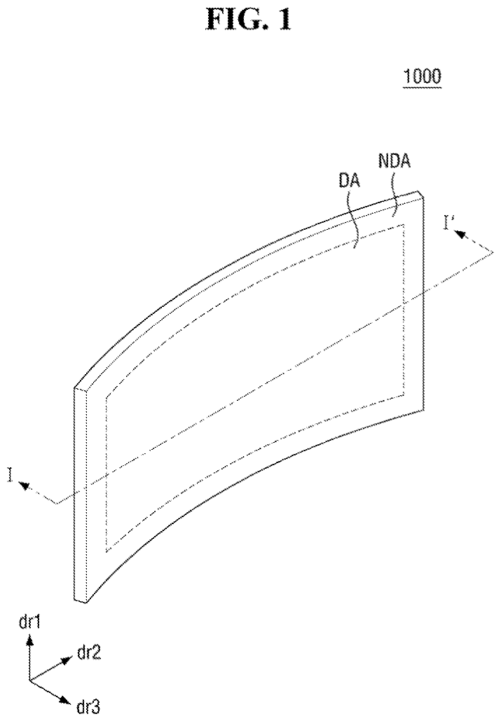

FIG. 1 is a perspective view of a display device according to an embodiment of the present disclosure.

Referring to FIG. 1, a display device 1000 according to an embodiment includes a display area DA and a non-display area NDA.

According to an embodiment, the display area DA is an area in which images are displayed. The display device 1000 includes a plurality of pixels in the display area DA. Specifically, the display area DA includes multicolor light-emitting areas, and one light-emitting area corresponds to one pixel. The display area DA can be used not only for displaying images, but also for detecting a touch input from a user.

According to an embodiment, the display device 1000 has a bent shape. The display device 1000 is bent along an axis extending in a first direction dr1 or an axis extending in a second direction dr2, which intersects the first direction dr1. The first and second directions dr1 and dr2 refer to relative directions and should be understood as being directions that intersect each other. A third direction dr3 can be understood as being a direction that intersects both the first and second directions dr1 and dr2, i.e., the normal direction of the display area DA.

In an embodiment, the display device 1000 has a first-direction axis, which is a straight line that extends in the first direction dr1 and a second-direction axis, which is a curved line that generally extends in the second direction dr2 and is concavely curved in the third direction dr3. However, the direction in which the display device 1000 is bent or curved is not particularly limited. In another embodiment, the first- and second-direction axes may both be curved lines. In yet another embodiment, the first-direction axis may be a curved line, and the second-direction axis may be convexly curved in the third direction dr3.

According to an embodiment, the non-display area NDA is an area in which no images are displayed. The non-display area NDA is disposed on the outside of the display area DA. The non-display area NDA surrounds the display area DA. The non-display area NDA includes parts that are concavely curved in the third direction dr3 to conform to the shape of the display area DA.

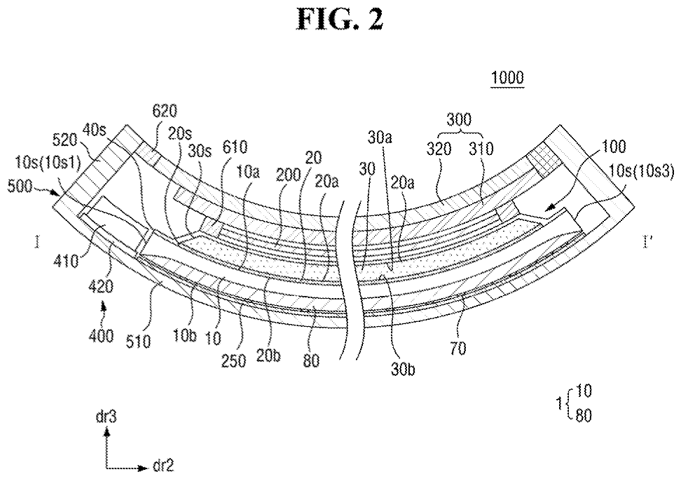

A cross-sectional structure of the display device 1000 will hereinafter be described with reference to FIG. 2.

FIG. 2 is a cross-sectional view taken along line I-I′ of FIG. 1. It is noted that for convenience, the thickness of the display device 1000 is exaggerated in FIG. 2.

Referring to FIG. 2, according to an embodiment, the display device 1000 includes a light source module 400, an optical member 100 disposed on the path of light emitted from the light source module 400, and a display panel 300 disposed above the optical member 100.

According to an embodiment, the optical member 100 includes a light guide plate 1, a first low refractive index layer 20 disposed on the light guide plate 1, a wavelength conversion layer 30 disposed on the first low refractive index layer 20, and a passivation layer 40 disposed on the wavelength conversion layer 30. The light guide plate 1, the first low refractive index layer 20, the wavelength conversion layer 30, and the passivation layer 40 may be combined together into one integral body.

According to an embodiment, the light source module 400 is disposed on one side of the optical member 100. The light source module 400 is adjacent to a light incidence surface 10s1 of the light guide plate 1 of the optical member 100. The light incidence surface 10s1 of the light guide plate 1 is a first side surface 10s1 of a supporting part 10. The light source module 400 includes a plurality of point or line light sources. The point light sources are light-emitting diodes (LEDs) 410. The LEDs 410 are mounted on a printed circuit board 420. The LEDs 410 emit light of a particular wavelength. In the description that follows, it is assumed that the LEDs 410 emit blue-wavelength light.

In an embodiment, the LEDs 410 are side-emitting LEDs. In this case, the printed circuit board 420 is disposed on a bottom surface 510 of a housing 500. The location of the LEDs 410 is not particularly limited. In another embodiment, the LEDs 410 are top-emitting LEDs that emit light through their top surfaces.

According to an embodiment, blue-wavelength light emitted from the LEDs 410 is incident upon the light guide plate 1 of the optical member 100. The light guide plate 1 of the optical member 100 guides light and emits the light through a top surface 10a or a bottom surface 10b of the light guide plate 1. The wavelength conversion layer 30 of the optical member 100 converts some of the blue-wavelength light incident thereupon into, for example, green- and red-wavelength light. The green- and red-wavelength light is emitted upwardly together with non-converted blue-wavelength light toward the display panel 300.

According to an embodiment, the display device 1000 further includes a reflective member 250 disposed below the optical member 100. The reflective member 250 includes a reflective film or a reflective coating layer. The reflective member 250 reflects light emitted toward the bottom surface 10b of the light guide plate 1 back toward the light guide plate 1.

According to an embodiment, the display panel 300 is disposed above the optical member 100. The display panel 300 receives light from the optical member 100 and displays an image. Examples of a light-receiving display panel which receives light and displays an image include a liquid crystal display (LCD) panel and an electrophoretic display panel (EPD). In the description that follows, it is assumed that the display panel 300 is an LCD panel, but embodiments of the present disclosure are not limited thereto. That is, various light-receiving display panels may be used as the display panel 300.

According to an embodiment, the display panel 300 includes a first substrate 310, a second substrate 320 that faces the first substrate 310, and a liquid crystal layer disposed between the first and second substrates 310 and 320. The first and second substrates 310 and 320 overlap each other. In an embodiment, one of the first or second substrates 310 and 320 is larger than the other substrate and thus protrudes beyond the other substrate. FIG. 2 illustrates that the second substrate 320, which is disposed on the first substrate 310, is larger than the first substrate 310 and protrudes beyond the first substrate 310 on a side of the display device 1000 where the light sources 400 are disposed. A protruding part of the second substrate 320 that protrudes beyond the first substrate 310 provides a space in which a driving chip or an external circuit board can be mounted. Alternatively, the first substrate 310, which is disposed below the second substrate 320, may be larger than the second substrate 320 and may thus protrude beyond the second substrate 320. The first and second substrates 310 and 320, except for the protruding part of the second substrate 320, are substantially aligned with side surfaces 10s of the light guide plate 1 of the optical member 100.

According to an embodiment, the optical member 100 is coupled to the display panel 300 via an intermodular coupling member 610. The intermodular coupling member 610 has a shape of a rectangular frame in a plan view. The intermodular coupling member 610 is disposed along the edges of each of the display panel 300 and the optical member 100.

In an embodiment, the intermodular coupling member 610 is disposed between the passivation layer 40 of the optical member 100 and the first substrate 310 of the display panel 300. The bottom surface of the intermodular coupling member 610 is disposed on the passivation layer 40 to overlap a top surface 30a of the wavelength conversion layer 30, but not with side surfaces 30s of the wavelength conversion layer 30.

According to an embodiment, the optical member 100 and the display panel 300 are fixed together by the intermodular coupling member 610. For example, the intermodular coupling member 610 can be an adhesive that fixes the passivation layer 40 of the optical member 100 and the first substrate 310 of the display panel 300 together. The intermodular coupling member 610 may include a polymer resin or an adhesive tape.

According to an embodiment, the display device 1000 further includes the housing 500. The housing 500 is open at one surface thereof, and includes a bottom surface 510 and side surfaces 520 connected to the bottom surface 510. The light source module 400, the optical member 100, the intermodular coupling member 610, and the reflective member 250 are received in a space delimited by the bottom surface 510 and the side surfaces 520.

According to an embodiment, the light source module 400, the optical member 100, the intermodular coupling member 610, and the reflective member 250 are disposed on the bottom surface 510 of the housing 500. The height of sidewalls 520 of the housing 520 is substantially the same as the height of the assembly of the optical member 100, the display panel 300 and the intermodular coupling member 610, which are disposed inside the housing 500. The display panel 300 is disposed between upper parts of the sidewalls 520 of the housing 500 and is coupled to the upper parts of the sidewalls 520 via a housing coupling member 620. The housing coupling member 620 has the shape of a rectangular frame in a plan view.

According to an embodiment, the housing 500 and the display panel 300 are fixed together by the housing coupling member 620. For example, the housing coupling member 620 can be an adhesive that fixes the sidewalls 520 of the housing 500 and the second substrate 320 of the display panel 300 together. The housing coupling member 620 may include a polymer resin or an adhesive tape.

According to an embodiment, the display device 100 further includes at least one optical film 200. The optical film 200 is received in a space surrounded by the intermodular coupling member 610 between the optical member 100 and the display panel 300. The sides of the optical film 200 are in contact with, and attached, to the inner side surfaces of the intermodular coupling member 610. FIG. 2 shows gaps between the optical film 200 and the optical member 100 and between the optical film 200 and the display panel 300, but the gaps may be unnecessary. Alternatively, the optical film 200 may be in contact with the optical member 100 and the display panel 300, in which case, the intermodular coupling member 610 need not be provided.

According to an embodiment, the optical film 200 may be a prism film, a diffusion film, a micro-lens film, a lenticular film, a polarizing film, a reflective polarizing film, or a retardation film. The display device 1000 may include a plurality of optical films 200 that are the same or different. In a case where a plurality of optical films 200 are used, the plurality of optical films 200 are disposed to overlap one another, and the sides of each of the plurality of optical films 200 are in contact with, and attached to, the inner side surfaces of the intermodular coupling member 610. The plurality of optical films 200 may be spaced apart from one another, with air layers in between the plurality of optical films 200.

In an embodiment, a composite film into which two or more optical functional layers are integrated can be used as the optical film 200.

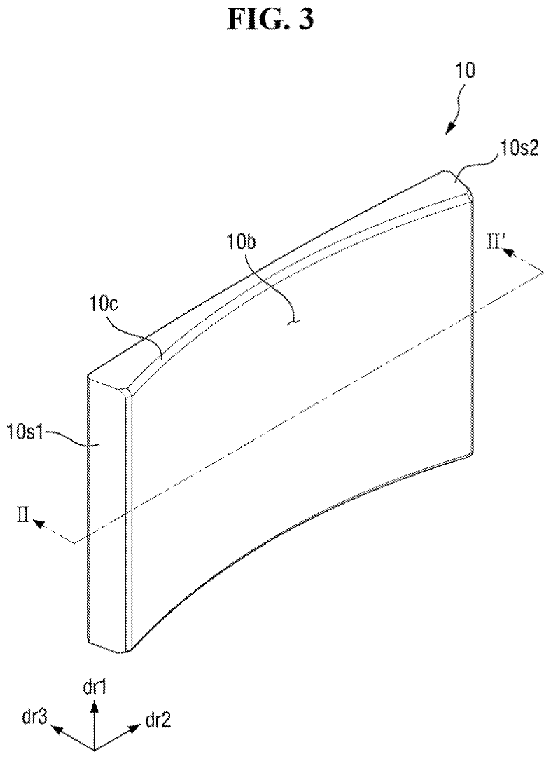

The light guide plate 1 according to an embodiment will hereinafter be described with reference to FIGS. 3 through 7.

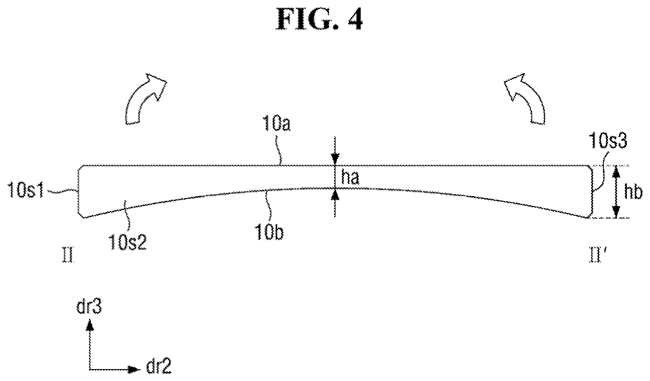

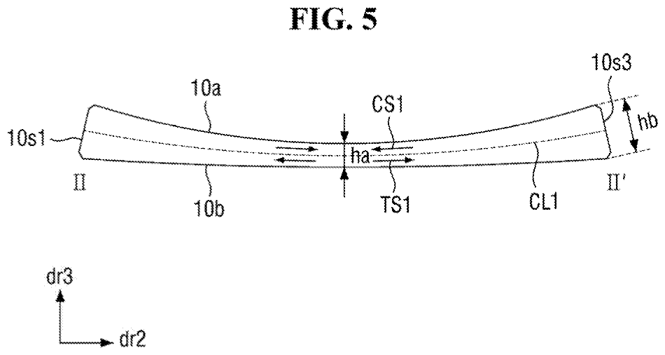

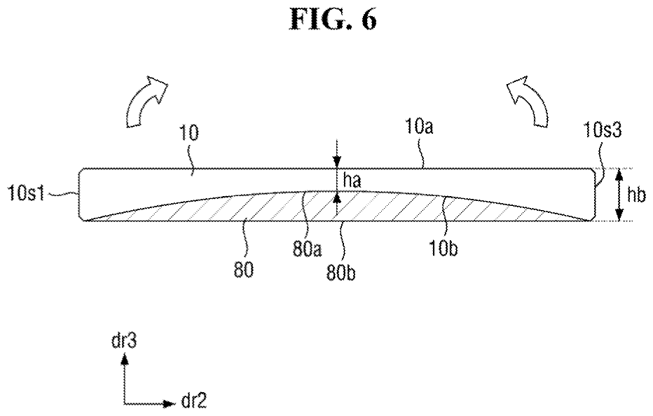

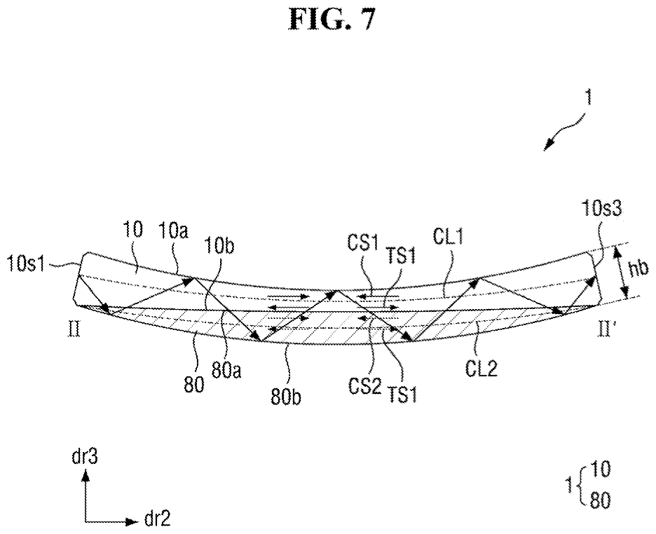

FIG. 3 is a perspective view of a supporting part of a light guide plate that is not yet curved. FIG. 4 is a cross-sectional view taken along line II-II′ of FIG. 3. FIG. 5 is a cross-sectional view of a supporting part of a light guide plate that has already been curved. FIG. 6 is a cross-sectional view that illustrates a case where a first relieving part is coupled to a light guide plate of FIG. 4. FIG. 7 is a cross-sectional view that illustrates a case where a first relieving part is coupled to a light guide plate of FIG. 5.

The light guide plate 1 guides the path of light. According to an embodiment, the light guide plate 1 is obtained by coupling the supporting part 10 and a first relieving part 80. The first relieving part 80 is disposed directly on a top surface or a bottom surface of the supporting part 10. In some embodiments, the first relieving part 80 is omitted from the light guide plate 1, and the light guide plate 1 includes only the supporting part 10.

According to an embodiment, the light guide plate 1 is obtained by a curving step that bends the light guide plate 1 such that both ends of the light guide plate 1 are bent in a thickness direction toward the center of the top surface 10a of the supporting part 10.

A light guide plate 1 that has not yet been subjected to the curving step will hereinafter be described.

According to an embodiment, the supporting part 10 has a cross-sectional shape of a polygonal column. The supporting part 10 has a rectangular shape in a plan view, but embodiments of the present disclosure are not limited thereto. In an embodiment, the supporting part 10 has a octagonal columnar cross-sectional shape, is rectangular in a plan view and has one recessed surface. The supporting part 10 includes the top surface 10a, the bottom surface 10b, and four side surfaces 10s, i.e., first, second, third, and fourth side surfaces 10s1, 10s2, 10s3, and 10s4. The top surface 10a and the bottom surface 10b of the supporting part 10 are opposite to each other, and the four side surfaces 10s connect the top surface 10a and the bottom surface 10b directly or indirectly. The thickness of the supporting part 10 is defined by the top surface 10a and the bottom surface 10b.

For convenience, the four side surfaces of the supporting part 10 are referred to as the first, second, third, and fourth side surfaces 10s1, 10s2, 10s3, and 10s4, but otherwise, can be collectively referred to as the side surfaces 10s.

The top surface 10a and the four side surfaces 10s of the supporting part 10 can be collectively referred to as the top surface and the four side surfaces of the light guide plate 1.

According to an embodiment, at least one of the top surface 10a and the bottom surface 10b has a curved shape. Accordingly, the thickness of the supporting part 10 varies from one location to another location. In an embodiment, the top surface 10a is flat, and the bottom surface 10b is curved. The thickness of the supporting part 10 becomes greater closer to the side surfaces 10a. That is, the supporting part 10 is thinnest at the center. For example, a second thickness ha, which is the thickness of the supporting part 10 at the center of the supporting part 10, is about 0.4 to 0.6 times a first thickness hb, which is the thickness of the supporting part 10 at the side surfaces 10s. In an embodiment, the first thickness hb is about 1.5 mm, and the second thickness ha is about 0.75 mm. The top surface 10a and the side surfaces 10s form an angle of about 90° with corner surfaces 10c interposed therebetween. The bottom surface 10b and the side surfaces 10s form an acute angle with corner surfaces 10c interposed therebetween. Before the curving step, the center of the curvature radius of the bottom surface 10b of the supporting part 10 is located below the bottom surface 10b.

According to an embodiment, the first and third side surfaces 10s1 and 10s3 of the supporting part 10 are parallel to each other and may have a substantially rectangular shape in a plan view. The second and fourth side surfaces 10s2 and 10s4 of the supporting part 10 are parallel to each other and are connected to the first and third side surfaces 10s1 and 10s3. The horizontal length of the first and third side surfaces 10s1 and 10s3 is less than the horizontal length of the second and fourth side surfaces 10s2 and 10s4. The term “horizontal length”, as used herein, refers to the length in a direction that intersects the thickness direction of the supporting part 10, i.e., the third direction dr3, and the term “vertical length”, as used herein, refers to the length in the thickness direction of the supporting part 10. That is, the vertical direction of the first through fourth side surfaces 10s1 through 10s4 refers to the third direction r3, the horizontal direction of the first and third side surfaces 10s1 and 10s3 refers to the first direction dr1, and the horizontal direction of the second and fourth side surfaces 10s2 and 10s4 refers to the second direction dr2.

According to an embodiment, the vertical length of the first and third side surfaces 10s1 and 10s3 is uniform regardless of location. Each of the second and fourth side surfaces 10s2 and 10s4 of the supporting part 10 has a concave edge. The vertical length of the second and fourth side surfaces 10s2 and 10s4 varies from location to location and corresponds to the thickness of the supporting part 10.

According to an embodiment, the supporting part 10 further includes the corner surfaces 10c, which are disposed between the top surface 10a and the side surfaces 10s or between the bottom surface 10b and the side surfaces 10s, and are relatively narrow.

According to an embodiment, the top surface 10a and the bottom surface 10b of the light guide plate 1 meet first sides of the corner surfaces 10c, and the side surfaces 10s meet second sides of the corner surfaces 10c. The corner surfaces 10c are inclined with respect to the top surface 10a, the bottom surface 10b and to the side surfaces 10s. The angle that the corner surfaces 10c form with the top surface 10a and the bottom surface 10b is smaller than the angle that the corner surfaces 10c form with the side surfaces 10s. The angle that the corner surfaces 10c form with the top surface 10a and the angle that the corner surfaces 10c form with the side surfaces 10c are obtuse angles. For example, the angle that the corner surfaces 10c form with the top surface 10a is an obtuse angle of about 135° or less.

The corner surfaces 10c alleviate the sharpness of the corners of the supporting part 10 and thus prevent damage to the supporting part 10 from an external impact. The corner surfaces 10c may be flat or may be curved.

According to an embodiment, the supporting part 10 includes an inorganic material. For example, the supporting part 10 may include glass or quartz, but embodiments of the present disclosure are not limited thereto.

According to an embodiment, the light guide plate 1 is bent by the curving step. That is, the supporting part 10 is bent. A top surface 10a and a bottom surface 10b of a supporting part 10 obtained by the curving step may both be curved, but embodiments of the present disclosure are not limited thereto. Alternatively, the bottom surface 10b, which is previously curved before the curving step, may become flat after the curving step.

In an embodiment, the curving step is performed in the same manner as a panel bending process known in the art. The panel bending process bends a panel into a recessed shape with a predetermined radius or curvature from an imaginary reference point. The curving step includes bending the second and fourth side surfaces 10s2 and 10s4 of the supporting part 10 such that the first and third side surfaces 10s1 and 10s3 of the supporting part 10 are directed toward the center of the top surface 10a.

According to an embodiment, the top surface 10a of the supporting part 10 obtained by the curving step includes a first curved area having a first curvature radius. The entire top surface 10a of the supporting part 10 obtained by the curving step corresponds to the first curved area. In an embodiment, the first curvature radius is from 1500 mm to 1800 mm, but embodiments of the present disclosure are not limited thereto. The bottom surface 10b of the supporting part 10 obtained by the curving step includes a second curved area having a second curvature radius, which differs from the first curvature radius. At least part of the bottom surface 10b of the supporting part 10 obtained by the curving step corresponds to the second curved area.

According to an embodiment, the centers of the curvature radii of the top surface 10a and the bottom surface 10b obtained by the curving step are both located above the top surface 10a. In this case, the first curvature radius is less than the second curvature radius. In some embodiments, the center of the first curvature radius of the top surface 10a obtained by the curving step is located above the top surface 10a, and the center of the second curvature radius of the bottom surface 10b obtained by the curving step is located below the bottom surface 10b.

According to an embodiment, a first compressive force CS1 and a first tensile force TS1 are applied above and below, respectively, an imaginary first center line CL1 between the top surface 10a and the bottom surface 10b of the supporting part 10. For example, the first compressive force CS1 is applied to a part of the supporting part 10 from the imaginary first center line CL1 to near the top surface 10a, and the first tensile force TS1 is applied to a part of the supporting part 10 from the imaginary first center line CL1 to near the bottom surface 10b. The imaginary first center line CL1 represents a location where the first compressive force CS1 and the first tensile force TS1 are in equilibrium and the resultant force of the first compressive force CS1 and the first tensile force TS1 becomes zero.

According to an embodiment, during the curving step, a tensile force σ is concentrated on an inflection line at the bottom surface 10b of the supporting part 10, and a maximum tensile force σ max is applied to a location where the tensile force σ is concentrated. The maximum tensile force σ max is the maximum of the first tensile TS1. For example, the tensile force σ may be concentrated on an inflection line at the bottom surface 10b of the supporting part 10 that meets the centers of the second and fourth side surfaces 10s2 and 10s4. Actually, the maximum tensile force σ max is applied to a location where the inflection line meets the corner surfaces 10c. The location in the supporting part 10 where the tensile force σ is concentrated can crack due to an internal or external impact, and such cracks can propagate in all directions throughout the supporting part 10. The maximum tensile force σ max is defined by Equation (1):

$${θ}_{max} = \frac{E h}{2 ( 1 - {v}^{2} ) R}$$

where σ denotes tensile force, E denotes Young's modulus, h denotes thickness, v denotes a Poisson's ratio, and R curvature radius.

According to Equation (1) above, assuming that the light guide plate 1 includes the same material, the maximum tensile force max is proportional to the thickness h and inversely proportional to the curvature radius R.

According to an embodiment, since the light guide plate 1 is narrower at the center than near the side surfaces 10s, the maximum tensile force σ max is reduced during the curving step. In addition, since the curvature radius R can be reduced by reducing the thickness h, the light guide plate 1 can be further bent during the curving step. Since the curvature is an inverse of the curvature radius R, it is possible to increase the curvature of the light guide plate 1 during the curving step.

According to an embodiment, the light guide plate 1 further includes a first relieving part 80 disposed directly on the bottom surface 10b of the supporting part 10. The first relieving part 80 is disposed directly on the second curved area of the supporting part 10.

According to an embodiment, the first relieving part 80 includes a transparent material. For example, the transparent material is an organic material that includes polyimide or silicon rubber. However, the material of the first relieving part 80 is not particularly limited, but may vary in other embodiments as long as an impact can be absorbed to prevent the supporting part 10 from being damaged by the first tensile force TS1.

According to an embodiment, the first relieving part 80 has a convex shape to correspond to the shape of the bottom surface 10b, which has a concave shape. That is, the first relieving part 80 is thinnest in parts near the first and third side surfaces 10s1 and 10s3 and is thickest at the center of the supporting part 10. The first relieving part 80 is formed in an area of the bottom surface 10b of the supporting part 10. Before the curving step, the thickness of the first relieving part 80 may be less than, or equal to, the maximum thickness of the bottom surface 10b.

According to an embodiment, the first relieving part 80 includes a top surface 80a and a bottom surface 80b that are opposite to each other. The top surface 80a of the first relieving part 80 is in contact with the bottom surface 10b of the supporting part 10. Before the curving step, the top surface 10a of the supporting part 10 and the bottom surface 80b of the first relieving part 80 are substantially parallel. In this case, the bottom surface 80b of the first relieving part 80 is flat.

According to an embodiment, even after the curving step, the top surface 10a of the supporting part 10 and the bottom surface 80b of the first relieving part 80 can also be substantially parallel. In this case, the bottom surface 80b includes a third curved area having a third curvature radius. For example, the third curved area covers the entire bottom surface 80b of the first relieving part 80. The first and third curved areas are parallel. The third curvature radius of the bottom surface 80b of the first relieving part 80 is greater than the first curvature radius of the top surface 10a of the supporting part 10.

According to an embodiment, the first relieving part 80, together with the supporting part 10, perform the functions of the light guide plate 1. The refractive index of the first relieving part 80 is substantially the same as the refractive index of the supporting part 10. Here, if the difference between the refractive indexes of two elements is 5% or less, it can be understood that the two elements have substantially the same refractive index. For example, if the supporting part 10 includes a glass having a refractive index of about 1.4 to about 1.55, then the first relieving part 80 includes silicon rubber having a refractive index of about 1.4 to about 1.6. Accordingly, light is not refracted at the interface between the first relieving part 80 and the supporting part 10 and is totally reflected inside the light guide plate 1 without being refracted. In some embodiments, the refractive index of the first relieving part 80 is exactly same as the refractive index of the supporting part 10

According to an embodiment, the supporting part 10 is subjected to the curving step with the first relieving part 80 coupled thereto. The maximum tensile force σ max is applied to the thinnest part of the bottom surface of the supporting part 10.

According to an embodiment, when the supporting part 10 is subjected to the curving step together with the first relieving part 80, a second compressive force CS2 is generated in parts of the first relieving part 80 near the interface between the supporting part 10 and the first relieving part 80. The resultant force of the second compressive force CS2, which is applied to the first relieving part 80, and the first tensile force TS1, which is applied to the supporting part 10, is applied to the interface between the supporting part 10 and the first relieving part 80. That is, the maximum tensile force of the supporting part 10 is reduced by the second compressive force CS2 of the first relieving part 80.

Specifically, according to an embodiment, there exists the imaginary first center line CL1 at which the resultant force of the first tensile force TS1 and the first compressive force CS1 in the supporting part 10 becomes zero, and the imaginary first center line CL1 bisects the thickness of the supporting part 10. After the curving step, the first compressive force CS1 is applied to the part of the supporting part 10 from the imaginary first center line CL1 to the top surface 10a, and the first tensile force TS1 is applied to the part of the supporting part 10 from the imaginary first center line CL1 to the bottom surface 10b.

Similarly, according to an embodiment, there exists an imaginary second center line CL2 at which the resultant force of a second tensile force TS2 and the second compressive force CS2 in the first relieving part 80 becomes zero, and the imaginary second center line CL2 bisects the thickness of the first relieving part 80. After the curving step, the second compressive force CS2 is applied to the first relieving part 80 from the imaginary second center line CL2 to the top surface 80a, and the second tensile force TS2 is applied to the first relieving part 80 from the imaginary second center line CL2 to the bottom surface 80b.

According to an embodiment, the light guide plate 1 is formed such that the bottom surface 10b of the supporting part 10 and the top surface 80a of the first relieving part 80 are in contact with each other, and after the curving step, the resultant force of the first tensile farce TS1 applied to the bottom surface 10b of the supporting part 10, and the second compressive force CS2 applied to the top surface 80a of the first relieving part 80 are applied to the interface between the supporting part 10 and the first relieving part 80. Accordingly, the maximum tensile force of the supporting part can be reduced as compared to a case when no first relieving part 80 is provided at the bottom surface 10b of the supporting part 10.

In addition, according to an embodiment, referring again to Equation (1) above, the light guide plate 1 can have a sufficiently large curvature. By combining the first relieving part 80 with the supporting part 10, the maximum tensile force of the supporting part 10 can be reduced, and as a result, the risk of cracks at the bottom surface 10b and the corner surfaces 10c of the supporting part 10 can be reduced, even if the light guide plate 1 is further bent.

Referring again to FIG. 2, according to an embodiment, a diffusion sheet 70 is disposed below the light guide plate 1. The diffusion sheet 70 changes the angle of light that is totally reflected inside the light guide plate 1 and thus allows the light to be emitted from the light guide plate 1.

In an embodiment, the diffusion sheet 70 is provided as a layer or a group of patterns. For example, either a pattern layer that includes protrusion patterns and recessed patterns, or printed patterns, may be formed on the bottom surface 10b of the light guide plate 1 to serve as the diffusion sheet 70.

In another embodiment, the diffusion sheet 70 is formed by surface patterns on the supporting part 10. For example, recessed grooves can be formed on the bottom surface 10b of the supporting part 10 to serve as the diffusion sheet 70.

According to an embodiment, the density of the patterns of the diffusion sheet 70 varies from one location to another location. For example, the density of the patterns of the diffusion sheet 70 is low in areas near the light incidence surface 10s1 that receive a relatively large amount of light and are high in areas near the opposite side surface 10s3 that receive relatively small amount of light.

According to an embodiment, the first low refractive index layer 20 is disposed on the top surface 10a of the supporting part 10. In an embodiment, the first low refractive index layer 20 is a lenticular sheet.

According to an embodiment, the first low refractive index layer 20 is formed directly on the top surface 10a of the light guide plate 1 and is in contact with the top surface 10a. The first low refractive index layer 20 is interposed between the light guide plate 1 and the wavelength conversion layer 30 and helps the total reflection function of the light guide plate 1.

Specifically, according to an embodiment, for the light guide plate 1 to effectively guide light from the light incident surface 10s1 toward the opposite surface 10s3, the total reflection of light should take place at the top surface 10a and the bottom surface 10b of the light guide plate 1. One of the conditions for causing internal total reflection in the light guide plate 1 is that the refractive index of the light guide plate 1 is greater than the refractive index of a medium that forms an optical interface with the light guide plate 1. The lower the refractive index of the medium is, the greater the critical angle for total reflection becomes, and the more internal total reflection takes place.

For example, according to an embodiment, when the light guide plate 1 is formed of glass having a refractive index of about 1.51, the bottom surface 10b of the light guide plate 1 (or the bottom surface 80b of the first relieving part 80) is exposed to, and forms an optical interface with, an air layer having a refractive index of about 1. Thus, a sufficient total reflection can take place at the bottom surface 10b of the light guide plate 1, or the bottom surface 80b of the first relieving part 80.

According to an embodiment, since there exist optical functional layers integrally stacked on the top surface 10a of the light guide plate 1, total reflection may not occur at the top surface 10a. For example, when the light guide plate 1 has a refractive index of about 1.51, and if a material layer having a refractive index of 1.51 or higher is stacked on the top surface 10a of the light guide plate 1, total reflection will not take place at the top surface 10a. Similarly, if a material layer having a refractive index of about 1.49, which is slightly lower than the refractive index of the light guide plate 1, is stacked on the top surface 10a, some internal reflection may take place at the top surface 10a, but not as much as at the bottom surface 10b because of too large a critical angle. The wavelength conversion layer 30 has a refractive index of about 1.45 to 1.49. if the wavelength conversion layer 30 is stacked directly on the top surface 10a of the light guide plate 1 or directly on the bottom surface 80b of first relieving part 80, a sufficient internal reflection may not occur at the top surface 10a of the light guide plate 1.

According to an embodiment, the first low refractive index layer 20, which is interposed between the light guide plate 1 and the wavelength conversion layer 30 and forms an interface with the top surface 10a of the light guide plate 1, has a lower refractive index than the light guide plate 1, and can thus allow total reflection to take place at the top surface 10a of the light guide plate 1. In addition, the first low refractive index layer 20 has a lower refractive index than the wavelength conversion layer 30, and can thus allow a greater internal reflection to take place at the top surface 10a than when the wavelength conversion layer 30 is disposed directly on the top surface 10a.

According to an embodiment, the difference between the refractive index of the light guide plate 1 and the refractive index of the first low refractive index layer 20 is greater than 0.2. If the difference between the refractive index of the light guide plate 1 and the refractive index of the first low refractive index layer 20 is less than 0.2, a sufficient internal reflection occurs at the top surface 10a of the light guide plate 1. There is no particular upper limit to the difference between the refractive index of the light guide plate 1 and the refractive index of the first low refractive index layer 20, but the difference between the refractive index of the light guide plate 1 and the refractive index of the first low refractive index layer 20 may be less than 1.

According to an embodiment, the first low refractive index layer 20 has a refractive index of 1.2 to 1.4. Generally, as the refractive index of a solid medium becomes closer to 1, the manufacturing cost of the solid medium increases exponentially. If the refractive index of the first low refractive index layer 20 is equal to or greater than 1.2, an increase in the manufacturing cost of the first low refractive index layer 20 can be prevented. The refractive index of the first low refractive index layer 20 is less than or equal to 1.4, which reduces the critical angle for total reflection at the top surface 10a of the light guide plate 1. In an embodiment, a first low refractive index layer 20 having a refractive index of about 1.25 may be used.

According to an embodiment, the first low refractive index layer 20 includes beads to lower the refractive index to about 1.25. The beads may be vacuum beads or may be filled with air, a gas, or etc. The beads may be particles or a matrix.

According to an embodiment, the wavelength conversion layer 30 is disposed on a top surface 20a of the first low refractive index layer 20. The wavelength conversion layer 30 converts the wavelength of at least some light incident thereupon. The wavelength conversion layer 30 includes a binder layer and wavelength conversion particles dispersed in the binder layer. The wavelength conversion layer 30 further includes scattering particles dispersed in the binder layer.

According to an embodiment, the binder layer in which the wavelength conversion particles are dispersed includes various resin compositions that can typically be referred to as binders, but embodiments of the present disclosure are not limited thereto. Nearly any type of medium that can disperse the wavelength conversion particles and the scattering particles therein can be referred to as a binder layer regardless of its actual name, function(s), or composition.

According to an embodiment, the wavelength conversion particles, which convert the wavelength of incident light, may be, for example, quantum dots (QDs), a fluorescent material or a phosphor material. Quantum dots have a nanometer-sized crystal structure and comprise several hundreds to thousands of atoms. Due to the small size of the quantum dots, there is an energy band gap, and a quantum confinement effect occurs. In response to light with higher energy than the energy band gap being incident upon quantum dots, the quantum dots absorb the incident light and transition to an excited state, emit light of a predetermined wavelength, and then fall back to the ground state. The light emitted by the quantum dots has a value corresponding to the energy band gap. The emission characteristics of the quantum dots, which result from quantum confinement, can be controlled by adjusting the size and the composition of the quantum dots.

According to an embodiment, the quantum dots include at least one of, for example, a Group II-VI compound, a Group II-V compound, a Group III-VI compound, a Group III-V compound, a Group IV-VI compound, a Group I-III-VI compound, a Group II-IV-VI compound, or a Group II-IV-V compound.

According to an embodiment, each of the quantum dots includes a core and a shell that overcoats the core. The core includes at least one of, for example, CdS, CdSe, CdTe, ZnS, ZnSe, ZnTe, GaN, GaP, GaAs, GaSb, AlN, AlP, AlAs, AlSb, InP, InAs, InSb, SiC, Ca, Se, In, P, Fe, Pt, Ni, Co, Al, Ag, Au, Cu, FePt, Fe2O3, Fe3O4, Si, or Ge. The shell includes at least one of, for example, ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InGaP, InAs, InSb, TlN, TlP, TlAs, TlSb, PbS, PbSe, or PbTe.

According to an embodiment, the wavelength conversion particles include a plurality of groups of wavelength conversion particles that convert incident light into different wavelengths. For example, the wavelength conversion particles include first wavelength conversion particles that convert the wavelength of incident light into a first wavelength, and second wavelength conversion particles that convert the wavelength of the incident light into a second wavelength. In one embodiment, light emitted from the light source module 400 to be incident upon the wavelength conversion particles has a blue wavelength, the first wavelength is a green wavelength, and the second wavelength is a red wavelength. For example, the blue wavelength has a peak at 420 nm to 470 nm, the green wavelength has a peak at 520 nm to 570 nm, and the red wavelength has a peak at 620 nm to 670 nm. However, the blue, green, and red wavelengths are not particularly limited and should be understood as encompassing all wavelength bands that are typically perceived as blue, green, and red wavelengths.

In an above embodiment, some blue light incident upon the wavelength conversion layer 30 is incident upon the first wavelength conversion particles to be converted into, and emitted as, green light, other blue light incident upon the wavelength conversion layer 30 is incident upon the second wavelength conversion particles to be converted into, and emitted as, red light, and still other blue light incident upon the wavelength conversion layer 30 is emitted as is without being incident upon the first wavelength conversion particles or the second wavelength conversion particles. Thus, light transmitted through the wavelength conversion layer 30 includes blue light, green light, and red light. By appropriately controlling the ratio of different colors of the emitted light, white light or light of various other colors can be emitted. Beams of light converted by the wavelength conversion layer 30 are concentrated in narrow wavelength bands and thus have a sharp spectrum with a narrow half width. Accordingly, color reproducibility can be improved by filtering light having such spectrum through color filters to realize colors.

In another embodiment, incident light may be short-wavelength light such as ultraviolet (UV) light, and the wavelength conversion layer 30 includes three groups of wavelength conversion particles that convert the wavelength of the short-wavelength light into blue, green, and red wavelengths to emit white light.

According to an embodiment, the wavelength conversion layer 30 further includes scattering particles. The scattering particles are non-quantum dot particles with no wavelength conversion function. The scattering particles scatter incident light and thus allow more of the incident light to be incident upon the wavelength conversion particles. In addition, the scattering particles can uniformly control the emission angle of light of each wavelength. Specifically, when light is incident upon the wavelength conversion particles and then wavelength-converted and emitted, the emitted light has a random scattering characteristic. If no scattering particles are provided in the wavelength conversion layer 30, green and red wavelengths emitted from the wavelength conversion particles have a scattering distribution characteristic, but blue wavelengths emitted without interacting with the wavelength conversion particles do not have a scattering distribution characteristic. Thus, the emission distributions of blue, green, and red wavelengths vary depending on the light emission angles. Since the scattering particles impart a scattering distribution characteristic even to blue wavelengths, the light emission angle of each wavelength can be uniformly controlled. TiO2 or SiO2 may be used for the scattering particles.

According to an embodiment, the wavelength conversion layer 30 is thicker than the first low refractive index layer 20. The wavelength conversion layer 30 has a thickness from about 10 μm to about 50 μm. In an embodiment, the wavelength conversion layer 30 has a thickness of about 15 μm.

According to an embodiment, the wavelength conversion layer 30 covers the top surface 20a of the first low refractive index layer 20 and completely overlaps the first low refractive index layer 20. The bottom surface 30b of the wavelength conversion layer 30 is in direct contact with the top surface 20a of the first low refractive index layer 20. In an embodiment, the side surfaces 30s of the wavelength conversion layer 30 are aligned with the side surfaces 20s of the first low refractive index layer 20. The side surfaces 30s of the wavelength conversion layer 30 have an inclination angle that is smaller than the inclination angle of the side surfaces 20s of the first low refractive index layer 20. As will be described below, if the wavelength conversion layer 30 is formed by, for example, slit coating, the side surfaces 30s of the wavelength conversion layer 30, which is relatively thick, have a smaller inclination angle than the side surfaces 20s of the first low refractive index layer 20, but embodiments of the present disclosure are not limited thereto. In another embodiment, the inclination angle of the side surfaces 30s of the wavelength conversion layer 30 are substantially equal to, or smaller than, the inclination angle of the side surfaces 20s of the first low refractive index layer 20, depending on how the wavelength conversion layer 30 is formed.

According to an embodiment, the wavelength conversion layer 30 is formed by, for example, coating. For example, the wavelength conversion layer 30 is formed by slit-coating a wavelength conversion composition on the light guide plate 1 with the first low refractive index layer 20 formed thereon and drying and curing the wavelength conversion composition, but embodiments of the present disclosure are not limited thereto. That is, various deposition methods may be used to form the wavelength conversion layer 30.

According to an embodiment, the passivation layer 40 is disposed on the first low refractive index layer 20 and the wavelength conversion layer 30. The passivation layer 40 prevents the penetration of moisture or oxygen. The passivation layer 40 includes an inorganic material. For example, the passivation layer 40 may include silicon nitride, aluminum nitride, zirconium nitride, titanium nitride, hafnium nitride, tantalum nitride, silicon oxide, aluminum oxide, titanium oxide, tin oxide, cerium oxide, or silicon oxynitride or may include a transparent metal film. For example, the passivation layer 40 can be formed of silicon nitride.

According to an embodiment, the passivation layer 40 completely covers the first low refractive index layer 20 and the wavelength conversion layer 30 from at least one side thereof. For example, the passivation layer 40 can completely cover the first low refractive index layer 20 and the wavelength conversion layer 30 from all sides thereof, but embodiments of the present disclosure are not limited thereto.

According to an embodiment, the passivation layer 40 completely overlaps the wavelength conversion layer 30, covers the top surface 30a of the wavelength conversion layer 30, and extends further outward from the top surface 30a to cover the side surfaces 30s of the wavelength conversion layer 30 and side surfaces 20s of the first low refractive index layer 20. The passivation layer 40 is in contact with the top surface 30a and the side surfaces 30s of the wavelength conversion layer 30 and the side surfaces 20s of the first low refractive index layer 20. The passivation layer 40 extends to the edge portions of the top surface 10a of the light guide plate 1 exposed by the first low refractive index layer 20, so that parts of edge portions of the passivation layer 40 are in direct contact with the top surface 10a of the light guide plate 1. In an embodiment, side surfaces 40s of the passivation layer 40 are aligned with the side surfaces 10s of the light guide plate 1. The inclination angle of the side surfaces 40s of the passivation layer 40 is greater than the inclination angle of the side surfaces 30s of the wavelength conversion layer 30. In addition, the inclination angle of the side surfaces 40s of the passivation layer 40 is greater than the inclination angle of the side surfaces 20s of the first low refractive index layer 20.

According to an embodiment, the thickness of the passivation layer 40 is less than the thickness of the wavelength conversion layer 30 and is equal to, or less than, the thickness of the first low refractive index layer 20. The thickness of the passivation layer 40 is from about 0.1 μm to about 2 μm. If the thickness of the passivation layer 40 is 0.1 μm or greater, the passivation layer 40 has a significant moisture/oxygen penetration preventing function. If the thickness of the passivation layer 40 is 0.3 μm or greater, the passivation layer 40 can provide an effective moisture/oxygen penetration preventing function. The passivation layer 40 may have a thickness of 2 μm or less in terms of transmittance. For example, the thickness of the passivation layer 40 is about 0.4 μm.

According to an embodiment, the wavelength conversion layer 30, particularly the wavelength conversion particles 22 in the wavelength conversion layer 30, are vulnerable to moisture and oxygen. In a wavelength conversion film, barrier films are laminated on the top and bottom surfaces thereof to prevent the penetration of moisture or oxygen into the wavelength conversion layer. On the other hand, in an embodiment of FIGS. 3 through 7, the wavelength conversion layer 30 has no barrier films, and thus a sealing structure is needed to protect the wavelength conversion layer 30. This sealing structure can be realized by the passivation layer 40 and the light guide plate 1.

Moisture can infiltrate into the wavelength conversion layer 30 through rough the top surface 30a, the side surfaces 30s, and the bottom surface 30b thereof. As described above, since the top surface 30a and the side surfaces 30s of the wavelength conversion layer 30 are covered and protected by the passivation layer 40, the infiltration of moisture or oxygen into the wavelength conversion layer 30 can be prevented or at least alleviated.

According to an embodiment, the bottom surface 30b of the wavelength conversion layer 30 is in contact with the top surface 20a of the first low refractive index layer 20. If the first low refractive index layer 20 includes voids or is formed of an organic material, moisture can diffuse within the first low refractive index layer 20, and thus, moisture or oxygen can infiltrate into the wavelength conversion layer 30 through the bottom surface 30b. However, in an embodiment of FIGS. 3 through 7, the first low refractive index layer 20 has a sealing structure. Thus, the infiltration of moisture or oxygen through the bottom surface 30b of the wavelength conversion layer 30 can be prevented.

Specifically, according to an embodiment, since the side surfaces 20s of the first low refractive index layer 20 are covered and protected by the passivation layer 40, the infiltration of moisture or oxygen through the side surfaces 20s of the first low refractive index layer 20 can be prevented or at least alleviated. Even if the first low refractive index layer 20 protrudes beyond the wavelength conversion layer 30 so that the top surface 20a is partially exposed, the infiltration of moisture or oxygen through the exposed part of the top surface 20a can be prevented or at least alleviated because the exposed part of the top surface 20a is covered and protected by the passivation layer 40. The bottom surface 20b of the first low refractive index layer 20 is in contact with the light guide plate 1. When the light guide plate 1 is formed of an inorganic material such as glass, the light guide plate 1, like the passivation layer 40, can prevent, or at least alleviate, the infiltration of moisture, or oxygen. In short, since the stack of the first low refractive index layer 20 and the wavelength conversion layer 30 is surrounded and sealed by the passivation layer 40 and the light guide plate 1, the infiltration of moisture or oxygen can be prevented or at least alleviated even if moisture or oxygen have diffused into the first low refractive index layer 20. Accordingly, the degradation of the wavelength conversion particles by moisture or oxygen can be prevented or at least alleviated.

According to an embodiment, the passivation layer 40 is formed by, for example, deposition. For example, the passivation layer 40 is formed on the light guide plate 1 with the first low refractive index layer 20 and the wavelength conversion layer 30 sequentially formed thereon using a chemical vapor deposition (CVD) method, but embodiments of the present disclosure are not limited thereto. That is, in other embodiments, various deposition methods other than CVD can be used to form the passivation layer 40.

According to an embodiment, as already described above, the optical member 100 is a single integral member that can simultaneously perform both an optical guide function and a wavelength conversion function. Accordingly, the assembly of the display device 1000 can be simplified. In addition, since the first low refractive index layer 20 is disposed on the top surface 10a of the light guide plate 1, total reflection can effectively occur at the top surface 10a of the light guide plate 1. Furthermore, since the first low refractive index layer 20 and the wavelength conversion layer 30 are sealed with the passivation layer 40, the degradation of the wavelength conversion layer 30 can be prevented.

In addition, according to an embodiment, due to the sealing structure of the wavelength conversion layer 30, the manufacturing cost and the thickness of the optical member 100 can be reduced, as compared to a case where a wavelength conversion film is provided as a separate film. For example, the wavelength conversion film may have barrier films attached to the top and the bottom thereof. The barrier films are not only expensive, but are as thick as 100 μm. Thus, the wavelength conversion film can be as thick as about 270 μm. On the other hand, since the first low refractive index layer 20 and the passivation layer 40 are formed to thicknesses of about 0.5 μm and about 0.4 μm, respectively, the total thickness of the optical member 100, except for the light guide plate 1, can be maintained at about 16 μm, and as a result, the thickness of the display device 1000 can be reduced. In addition, since expensive barrier films can be omitted from the optical member 100, the manufacturing cost of the optical member 100 can be reduced.

Light guide plates according to other embodiments of the present disclosure will hereinafter be described. Descriptions of elements that have already been described above will be omitted or at least simplified, and light guide plates according to other embodiments of the present disclosure will, hereinafter be described, focusing mainly on the differences with a light guide plate according to an embodiment of FIGS. 3 through 7. Although some of the following drawings show the arrangement or alignment of elements on one side of a light guide plate, the same structure may apply to more than one side or all sides of a light guide plate, or various structures may be combined.

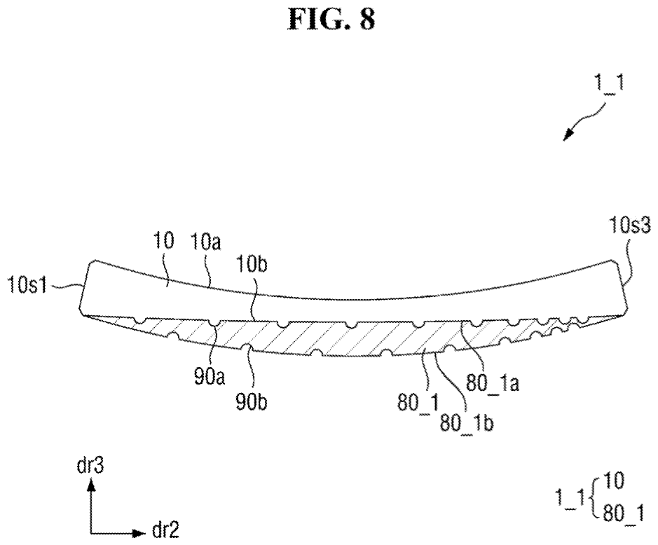

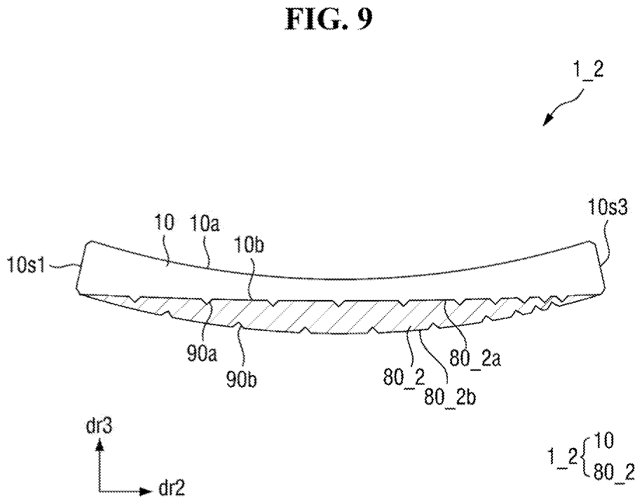

FIGS. 8 through 10 are cross-sectional views of light guide plates according to other embodiments of the present disclosure, which have already been curved. Specifically, FIGS. 8 through 10 illustrate modified examples of the light guide plate 1 of FIG. 7.

Referring to FIGS. 8 through 10, according to embodiments, a light guide plate 1_1, 1_2, or 1_3 differs from the light guide plate 1 of FIG. 7 in that a lint relieving part 80_1, 80_2, or 80_3 includes diffusion patterns 90a or diffusion patterns 90b.

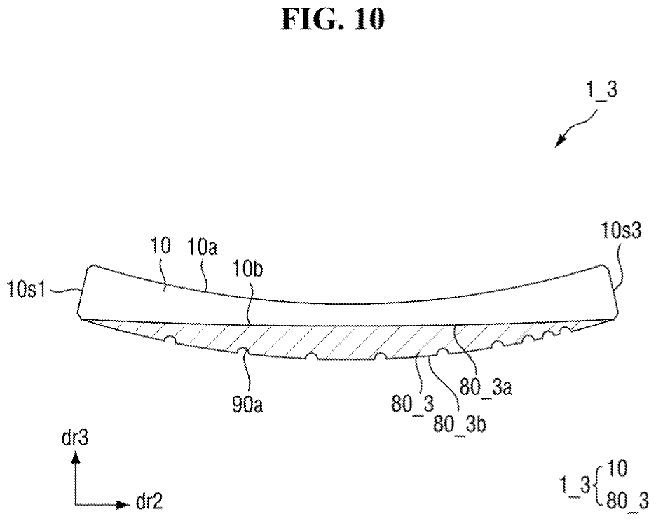

According to an embodiment, the first relieving part 80_1, 80_2 or 80_3 includes the diffusion patterns 90a or the diffusion patterns 90b, which are formed on top surfaces 80_1a, 80_2a, or 80_3a or bottom surfaces 80_1b, 80_2b, or 80_3b. Specifically, as illustrated in FIG. 8, the diffusion patterns 90a and the diffusion patterns 90b are respectively formed on the top surface 80_1a and the bottom surface 80_1b of the first relieving part 80_1. Alternatively, as illustrated in FIG. 10, the diffusion patterns 90a are formed only on the bottom surface 80_3b of the first relieving part 80_3. The diffusion patterns 90a and the diffusion patterns 90b change the angle of light that propagates within the light guide plate 1_1, 1_2, or 1_3 through total reflection, and thus allow the light to be emitted out of the light guide plate 1_1, 1_2, or 1_3.

According to an embodiment, the shapes of the diffusion patterns 90a and the diffusion patterns 90b may vary. The diffusion patterns 90a and the diffusion patterns 90b are formed on the first relieving parts 80_1, 80_2, or 80_3 as protrusions or recesses. The diffusion patterns 90a and the diffusion patterns 90b may have a semicircular shape, as illustrated in FIGS. 8 and 10, or may have a polygonal shape, as illustrated in FIG. 10.

According to an embodiment, the density of the diffusion patterns 90a or the diffusion patterns 90b varies from location to location. For example, the density of the diffusion patterns 90a and the diffusion patterns 90b is low in areas near the light incidence surface 10s1 that receive a relatively large amount of light and is high in areas near the opposite side surface 10s3 that receives a relatively small amount of light.

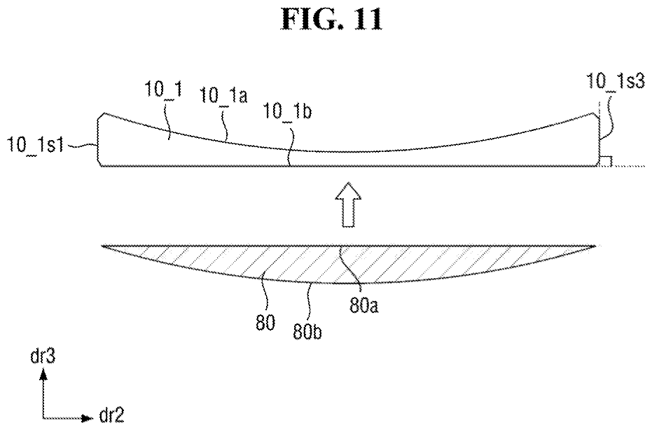

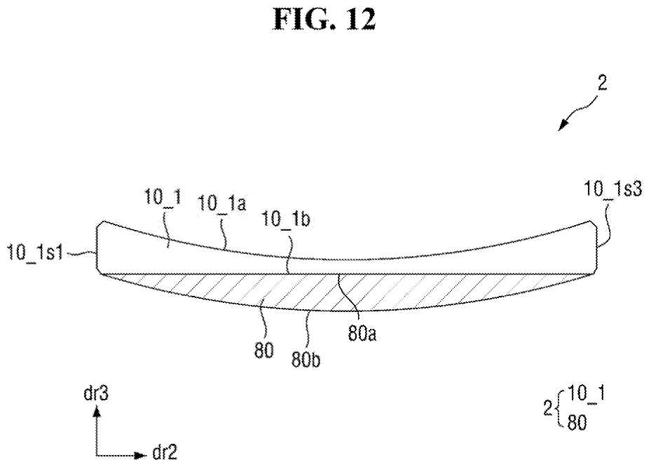

FIGS. 11 and 12 are cross-sectional views of a light guide plate according to an embodiment of the present disclosure. FIG. 11 shows a supporting part 10_1 and a first relieving part 80 of a light guide plate 2 that are separated, and FIG. 12 shows the supporting part 10_1 and the first relieving part 80 of FIG. 11 coupled together.

Referring to FIGS. 11 and 12, according to an embodiment, the light guide plate 2 differs from the light guide plate 1 of FIG. 7 in that a top surface 10_1a of the supporting part 10_1 is already curved without being subjected to a curving step.

According to an embodiment, the supporting part 10_1 is formed such that the top surface 10_1a is curved, and that a bottom surface 10_1b is flat. The top surface 10_1a of the supporting part 10 is concavely curved. The angle that the bottom surface 10_1b and side surfaces 10_1s form is a right angle, and the angle that the top surface 10_1a and the side surfaces 10_1s form is an acute angle.

According to an embodiment, the first relieving part 80 is disposed on the flat bottom surface 10_1b of the supporting part 10_1. A bottom surface 80b of the first relieving part 80 is formed to be substantially parallel to the top surface 10_1a of the supporting part 10_1a. A top surface 80a of the first relieving part 80 is flat, and the bottom surface 80b of the first relieving part 80 is convexly curved. Since the bottom surface 80b of the first relieving part 80 is substantially parallel to the top surface 10_1a of the supporting part 10_1, light can be effectively totally internally reflected within the light guide plate 2.

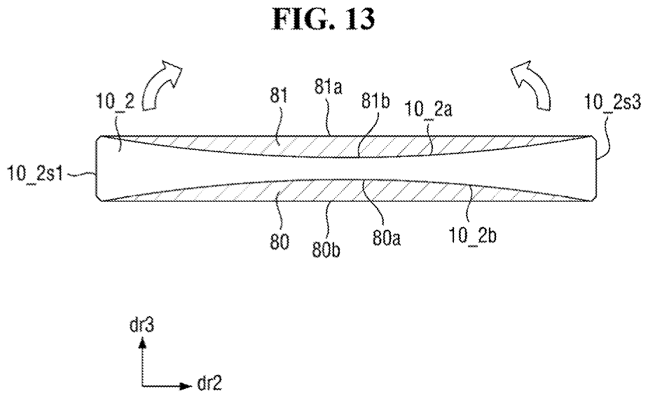

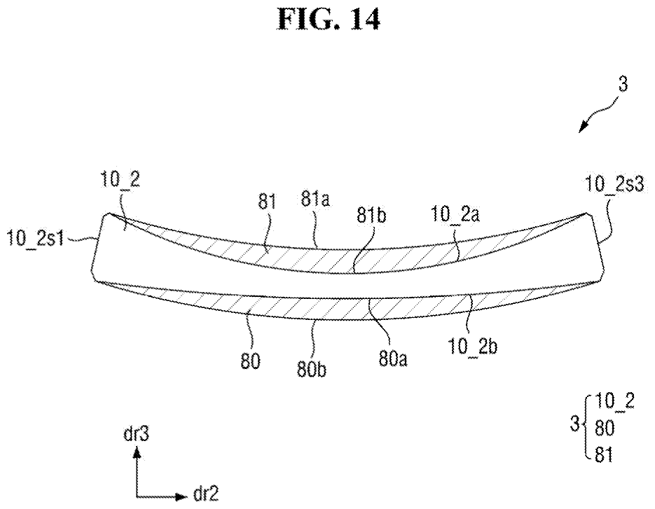

FIG. 13 is a cross-sectional view of a light guide plate according to an embodiment of the present disclosure that has not yet been subjected to a curving step. FIG. 14 is a cross-sectional view of a light guide plate obtained by subjecting a light guide plate of FIG. 13 to a curving step.

Referring to FIGS. 13 and 14, according to an embodiment, a light guide plate 3 differs from the light guide plate 1 of FIGS. 6 and 7 in that a top surface 10_2a of a supporting part 10_2 is curved, and that a second relieving part 81 is additionally disposed on the top surface 10_2a of the supporting part 10_2.

Before a curving step, according to an embodiment, the top surface 10_2a of the supporting part 10_2 is already curved. That is, both the top surface 10_2a and a bottom surface 10_2b of the supporting part 10_2 are curved. In this case, the center of the curvature radius of the top surface 10_2a is located above the top surface 10_2a, and the center of the curvature radius of the bottom surface 10_2b is located below the bottom surface 10_2b.

In an embodiment, after the curving step, the centers of the curvature radii of the top surface 10_2a and the bottom surface 10_2b of the supporting part 10_2 are both located above the top surface 10_2a of the supporting part 10_2, in which case, the curvature radius of the bottom surface 10_2b is greater than the curvature radius of the top surface 10_2a. In another embodiment, even after the curving step, the center of the curvature radius of the top surface 10_2a is still located above the top surface 10_2a of the supporting part 10_2, and the center of the curvature radius of the bottom surface 10_2b is still located below the bottom surface 10_2b.

According to an embodiment, the second relieving part 81 is coupled onto the top surface 10_2a of the supporting part 10_2. A bottom surface 81b of the second relieving part 81 is in contact with the top surface 10_2a of the supporting part 10_2. A top surface 81a of the second relieving part 81 is substantially parallel to a bottom surface 80b of a first relieving part 80, but embodiments of the present disclosure are not limited thereto.

According to an embodiment, the second relieving part 81 includes the same material as the first relieving part 80. The second relieving part 81 can reduce the maximum compressive force applied to the top surface 10_2a of the supporting part 10_2. A tensile force is applied to the bottom surface 81b of the second relieving part 81 and can offset the compressive force applied to the top surface 10_2a of the supporting part 10_2, which is in contact with the bottom surface 81b of the second relieving part 81. As a result, the supporting part 10_2 can be prevented from cracking due to the compressive force applied thereto.

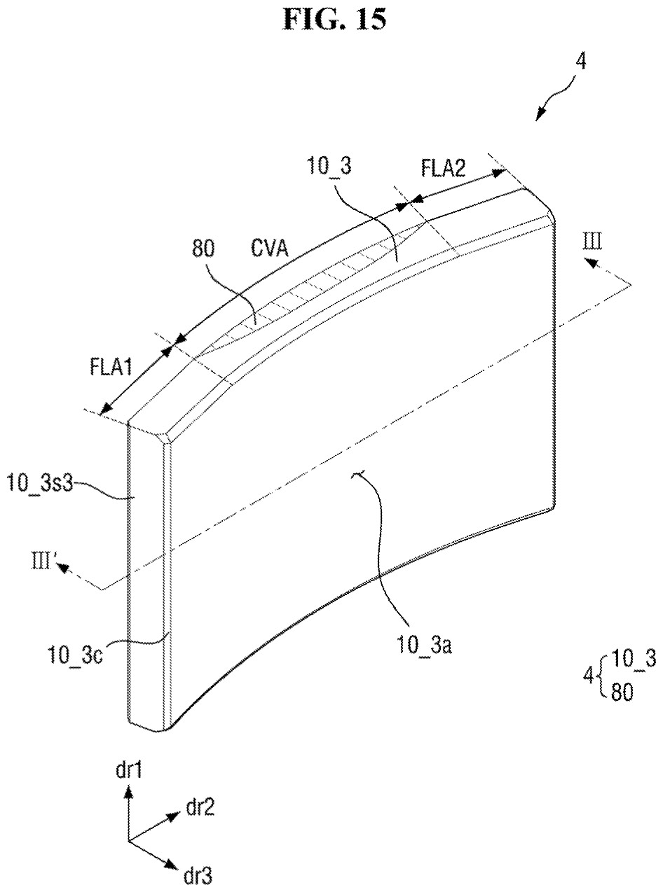

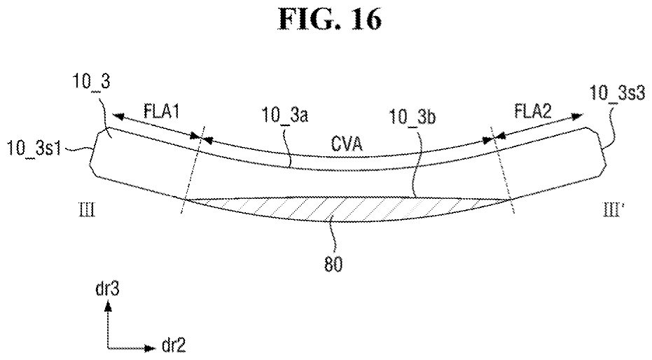

FIG. 15 is a perspective view of a light guide plate according to a embodiment of the present disclosure that has already been subjected to a curving step. FIG. 16 is a cross-sectional view taken along line III-III′ of FIG. 15. Specifically, FIG. 15 is a perspective view of a light guide plate 4 as viewed from an angle where a top surface 10_3a of a supporting part 10_3 is visible.

Referring to FIGS. 15 and 16, according to an embodiment, the light guide plate 4 differs from the light guide plate 1 of FIG. 7 in that both the top surface 10_3a and a bottom surface 10_3b of the supporting part 10_3 are partly curved and partly flat.

According to an embodiment, the top surface 10_3a of the supporting part 10_3 includes a curved area CVA and first and second flat areas FLA1 and FLA2 disposed on both sides of the curved area CVA. The first flat area FLA1 is adjacent to a third side surface 10_3s3 of the supporting part 10_3, and the second flat area FLA2 is adjacent to a first side surface 10_3s1 of the supporting part 10_3.

According to an embodiment, in the first and second flat areas FLA1 and FLA2, the top surface 10_3a of the supporting part 10_3 is flat. In parts of the light guide plate 4 that overlap the first and second flat areas FLA1 and FLA2, the bottom surface 10_3b of the supporting part 10_3 is flat. Accordingly, a first relieving part 80 can be omitted from the parts of the light guide plate 4 that overlap with the first and second flat areas FLA1 and FLA2.

According to an embodiment, the curved area CVA is disposed between the first and second flat areas FLA1 and FLA2. The supporting part 10_3 has a uniform curvature in the curved area CVA. The first relieving part 80 is disposed to overlap the curved area CVA.

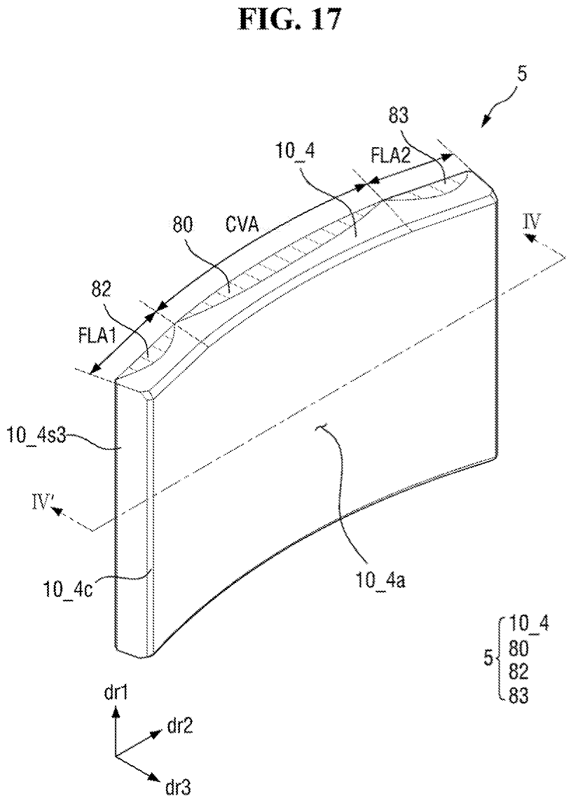

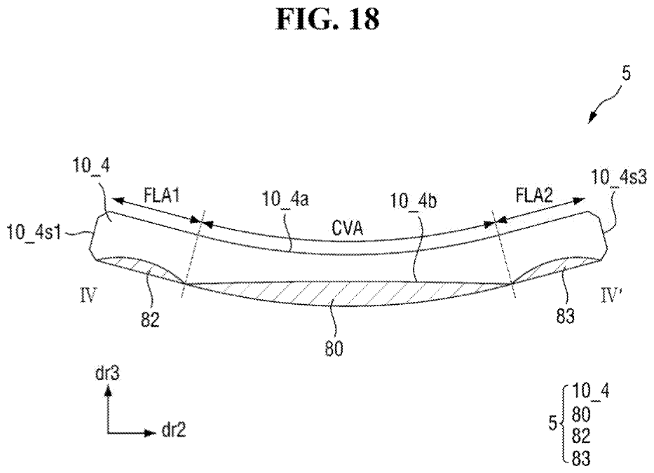

FIG. 17 is a perspective view of a light guide plate according to an embodiment of the present disclosure, which has already been subjected to a curving step. FIG. 18 is a cross-sectional view taken along line IV-IV′ of FIG. 17. Specifically, FIG. 17 is a perspective view of a light guide plate 4 as viewed from an angle where a top surface 10_4a of a supporting part 10_4 is visible.

Referring to FIGS. 17 and 18, according to an embodiment, the light guide plate 5 differs from the light guide plate 4 of FIGS. 15 and 16 in that it further includes third and fourth relieving parts 82 and 83 that overlap first and second flat areas FLA1 and FLA2, respectively, of a top surface 10_4a of the supporting part 10_4.

According to an embodiment, a bottom surface 10_4b of the supporting part 10_4 is curved in parts of the light guide plate 4 that overlap a curved area CVA and the first and second flat areas FLA1 and FLA2 of the top surface 10_4a.

According to an embodiment, the third relieving part 82 is disposed on the bottom surface 10_4b of the supporting part 10_4 to overlap the first flat area FLA1 of the top surface 10_4a of the supporting part 10_4. The fourth relieving part 83 is disposed on the bottom surface 10_4b of the supporting part 10_4 to overlap the second flat area FLA2 of the top surface 10_4a of the supporting part 10_4.

According to an embodiment, the light guide plate 1 of the display device 1000 of FIG. 2 may be replaced with any one of the light guide plates 1_1, 1_2, 1_3, 2, 3, 4 or 5 of FIGS. 8 through 18.

Although certain exemplary embodiments have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A light guide plate, comprising:
a supporting part that includes a first surface, a second surface opposite to the first surface, and side surfaces that connect the first and second surfaces,
wherein
the first surface includes a first curved area that has a first curvature radius, and
a center of the first curvature radius is located above the first surface.

2. The light guide plate of claim 1, wherein the supporting part includes an inorganic material.

3. The light guide plate of claim 1, wherein the second surface of the supporting part is flat.

4. The light guide plate of claim 1, wherein
a thickness of the supporting part, which is a distance between the first and second surfaces, varies from one part to another part of the supporting part,
the supporting part has a maximum thickness in areas near the side surfaces of the supporting part and has a minimum thickness at a center of the supporting part, and
the minimum thickness of the supporting part is 0.4 to 0.6 times the maximum thickness of the supporting part.

5. The light guide plate of claim 1, further comprising:
a first relieving part disposed directly on the first curved area of the supporting part,
wherein a maximum thickness of the first relieving part is less than the maximum thickness of the supporting part, and
the first relieving part includes an organic material.

6. The light guide plate of claim 5, wherein
the first relieving part includes a third surface in contact with the first surface of the supporting part and a fourth surface opposite to the third surface, and
the fourth surface of the first relieving part is parallel to the second surface of the supporting part.

7. The light guide plate of claim 6, wherein the first relieving part further includes a plurality of scattering patterns formed on the fourth surface.

8. The light guide plate of claim 5, wherein a difference in refractive index between the supporting part and the first relieving part is 5% or less.

9. The light guide plate of claim 5, wherein the first relieving part has a refractive index of 1.4 to 1.6.

10. The light guide plate of claim 1, wherein
the second surface of the supporting part includes a second curved area that has a second curvature radius, and
a center of the second curvature radius is located above the second surface.

11. The light guide plate of claim 10, further comprising:
a second relieving part disposed directly on the second curved area of the supporting part,
wherein the second relieving part includes an organic material.

12. A display device, comprising:
a light guide plate;
a wavelength conversion layer disposed on the light guide plate;
a display panel disposed on the wavelength conversion layer; and
a light source module disposed adjacent to one side surface of the light guide plate,
wherein
the light guide plate includes a supporting part that includes a first surface, a second surface opposite to the first surface, and side surfaces that connect the first and second surfaces, and a relieving part that includes a third surface in contact with the second surface of the supporting part and a fourth surface opposite to the third surface,
the first surface of the supporting part includes a first curved area that has a first curvature radius,
the second surface of the supporting part includes a second curved area that has a second curvature radius, and
the first and second curvature radii satisfy one of the following conditions (a) and (b):
(a) the second curvature radius is greater than the first curvature radius; or
(b) a center of the first curvature radius is located above the first surface, and a center of the second curvature radius is located above the second surface.

13. The display device of claim 12, wherein
the supporting part includes an inorganic material,
the relieving part includes an organic material, and
the wavelength conversion layer includes quantum dots.

14. The display device of claim 12, wherein the first curvature radius is 1500 mm to 1800 mm.

15. The display device of claim 12, wherein
the fourth surface includes a third curved area having a third curvature radius, and
the third curvature radius is greater than the first curvature radius.

16. The display device of claim 15, wherein the first curved area and the third curved area are parallel to each other.

7. The display device of claim 12, wherein the first surface of the supporting part further includes flat areas disposed on both sides of the first curved area.

18. The display device of claim 17, wherein the relieving part overlaps the first curved area of the supporting part.

19. A light guide plate, comprising:
a supporting part that includes a first surface and a second surface opposite to the first surface, wherein the first surface includes a first curved area that has a first curvature radius; and
a relieving part disposed directly on the first curved area of the supporting part,
wherein a difference in refractive index between the supporting part and the relieving part is 5% or less.

20. The light guide plate of claim 19,
wherein the supporting part further comprises side surfaces that connect the first and second surfaces,
wherein a thickness of the supporting part, which is a distance between the first and second surfaces, varies from one part to another part of the supporting part,
wherein the supporting part has a maximum thickness in areas near the side surfaces of the supporting part and has a minimum thickness at a center of the supporting part, and
wherein a maximum thickness of the relieving part is less than the maximum thickness of the supporting part.
